(19) United States
(12) Patent Application Publication
(10) Pub. No.: US 2006/0047229 A1
(43) Pub. Date: Mar. 2, 2006

(54) Stress relief vest

(76) Inventor: Alex Dussaussoy, Chicago, IL (US)

Correspondence Address: Paul E. Schaafsma;NovusIP, LLC, Suite 221, 521 West Superior, Chicago, IL, 60610, US

(21) Appl. No.: 10/933,079

(22) Filed: Sep. 2, 2004

(51) Int. Cl. A61H 1/00

(52) U.S. Cl. 601/46; 601/57; 601/79

(57) ABSTRACT

In accordance with the principles of the present invention, a garment for the human body provides relaxing (therapeutic) effects on the neck and the upper back and shoulder regions. A garment of the present invention is comprised of a flexible, supportive cervical collar that secures the head and neck. The cervical collar is secured to a partially fitted, flexible upper body vest. The vest portion includes weighted ballasts. A plurality of vibrators are provided on the vest located strategically at certain muscle/acupuncture sites.

### FIELD OF THE INVENTION

The present invention relates to providing relaxing (therapeutic) effects on the neck and the upper back and shoulder regions.

### BACKGROUND OF THE INVENTION

Various so-called alternative treatments to traditional “western” medicine exist. While traditional “western” medicine tends to focus on reactive and specific treatment of disease or symptoms, these alternative treatments work to allow the body to restore itself and normalize functions. One such alternative treatment is reflexology. Reflexology is a natural healing art based on the principle that there are reflexes in the hands, feet, and ears that correspond to every part, gland, and organ of the body. Through application of pressure on these reflexes, reflexology relieves tension, improves circulation, and promotes the natural function of the related areas of the body.

In ancient times reflexes were stimulated naturally by walking barefoot over rocks, stones, and rough ground, or by using hands more often to climb, build or work. In today's modern world, much of nature's way of maintaining a balanced and healthy equilibrium has been lost. Reflexology helps to restore this balance and promote natural healing and vitality.

Although Reflexology does not diagnose or treat specific ailments by definition, it has been shown to be successful over time to relieve symptoms or ease pain or discomfort that have manifested themselves physically in the body—either as a result of stress, trauma or disease.

Reflexology has been practiced for thousands of years in such places as India, China and Egypt. An ancient Egyptian wall painting of the 6th Dynasty (approx. 2400 B.C.E.) found at Saqqara in the tomb of Ankhmahor, an ancient Egyptian physician, depicts two men working on the feet and hands of two other men. Reflexology has been used as a healing therapy by the North American native people for generations, and is thought to have been passed down by the Inca civilization.

Another such alternative treatment is acupressure or Tui Na (Tuina). Tuina involves applying strokes to acupoints, channels, and muscle groups. Tuina therapy dates back to the Shang Dynasty of China, 1700 B.C.E. Oracle bones show that Tuina massage was used to treat children's diseases and digestive complaints in adults. By 600 C.E. Tuina was included in the Imperial Medical College as a separate department. Tuina methods include use of hand techniques to massage the soft tissue (muscles and tendons) of the body, acupressure techniques to directly affect the flow of Qi (described below), and manipulation techniques to realign the musculoskeletal and ligamentous relationships (bone-setting).

Tuina is well suited for the treatment of specific musculoskeletal disorders and chronic stress-related disorders of the digestive, respiratory, and reproductive systems. Effective treatment protocols have been tested in a practical setting. Tuina is not especially useful for those seeking a mild, sedating, and relaxing massage since it tends to be more task focused than other types of bodywork.

Tuina involves applying strokes to acupoints. Acupoints are specific points in the body that are used in the ancient medical art of acupuncture. Acupuncture (and its related Moxibustion) are practiced medical treatments that are over 5,000 years old. Acupuncture involves the insertion of very fine needles (sometimes in conjunction with electrical stimulus) on the body's surface, in order to influence physiological functions of the body.

The first record of acupuncture is found in the 4,700 year old Huang Di Nei Jing (Yellow Emperor's Classic of Internal Medicine). This is believed to be the oldest medical textbook in the world. It is said to have been written down from even earlier theories by Shen Nung, the father of Traditional Chinese Medicine. Shen Nung documented theories about circulation, pulse, and the heart over 4,000 years before European medicine had any concept about them.

As the basis of acupuncture, an energy force runs throughout the body. This energy force is known as Qi (roughly pronounced Chee). The Qi consists of essential life activities, which include the spiritual, emotional, mental, and physical aspects of life. A person's well being is influenced by the flow of Qi in the body, in combination with the universal forces of Yin and Yang.

Yin and Yang is an important theory in the discussion of acupuncture treatment, in relation to the Traditional Chinese theory of body systems. Qi is comprised of two parts, Yin and Yang. Yin and Yang are opposite forces, that when balanced, work together in harmony. Any upset in the balance can result in disease in humans.

Energy constantly flows up, down, in and out through the body. If the flow of Qi is insufficient, blocked or interrupted, Yin and Yang become unbalanced, and illness may occur. Qi travels throughout the body along “Meridians” or special pathways. These Meridians (or Channels) are the same on both sides of the body (paired). Fourteen main meridians run vertically up and down the surface of the body. Out of these, there are twelve organ Meridians in each half of the body. There are also two unpaired midline Meridians. The acupuncture points are specific locations where the Meridians come to the surface of the skin and are easily accessible. The connections between them ensure that there is an even circulation of Qi: a balance between Yin and Yang.

It is known that acupuncture works. The question arises, how does acupuncture work? There are a few prevailing theories. In one theory, by some unknown process acupuncture raises levels of triglycerides, specific hormones, prostaglandins, white blood counts, gamma globulins, opsonins, and overall anti-body levels. This is called the “Augmentation of Immunity” theory. The “Endorphin” theory states that acupuncture stimulates the secretions of endorphins in the body (specifically Enkaphalins). The “Neurotransmitter” theory states that certain neurotransmitter levels (such as Seratonin and Noradrenaline) are affected by acupuncture. The “Circulatory” theory states that acupuncture has the effect of constricting or dilating blood vessels. This may be caused by the body's release of Vasodilaters (such as Histamine) in response to acupuncture.

One of the most popular theories is the “Gate Control” theory. According to the Gate Control theory, the perception of pain is controlled by a part of the nervous system that regulates the impulse, which will later be interpreted as pain. This part of the nervous system is called the “gate.” If the gate is hit with too many impulses, it becomes overwhelmed, and it closes. This prevents some of the impulses from getting through. The first gates to close would be the ones that are the smallest. The nerve fibers that carry the impulses of pain are rather small nerve fibers called “C” fibers. These are the gates that close during acupuncture.

In the related “Motor Gate” theory, some forms of paralysis can be overcome by acupuncture. This is done by reopening a “blocked” gate, which is connected to an Anterior Horn cell. The gate, when obstructed by disease, stops motor impulses from reaching muscles. This theory was first stated by Professor Jayasuriya in 1977:
“ . . . one of the factors contributing to motor recovery is almost certainly the activation of spindle cells. They are stimulated by Gamma motor neurons. If Acupuncture stimulates the Gamma motor neurons, the discharge causes the contraction of Intrafusal Muscle fibers. This activates the Spindle cells, in the same way as muscle stretching. This will bring about muscle contraction.”
   Prof. Dr. Sir Anton Jayasuriya: Paper for the 5th World Congress of Acupuncture; 1977 Tokyo, Japan.

One drawback of these alternative treatments to traditional “western” medicine is that to become a competent, professional reflexologist, acupressurist, or acupuncturist, years of study and practice are required. In order to repay this investment of time and resources, these professionals must charge fees for treatment of patients. Also, the patient typically makes an appointment and goes to the professional's office, thus incurring time and inconvenience.

What would thus be desirable would be an improved apparatus for applying relaxing (therapeutic) effects on the neck and the upper back and shoulder regions. It would be further desirable that an improved apparatus for applying relaxing (therapeutic) effects on the neck and the upper back and shoulder regions works to allow the body to restore itself and normalize functions. It would be further desirable that such relaxing (therapeutic) effects could be applied in a non-invasive manner and without the assistance of a professional.

### SUMMARY OF THE INVENTION

In accordance with the principles of the present invention, a garment is provided to provide relaxing (therapeutic) effects on the neck and the upper back and shoulder regions. A garment in accordance with the principles of the present invention works to allow the body to restore itself and normalize functions. A garment in accordance with the principles of the present invention applies such relaxing (therapeutic) effects in a non-invasive manner and without the assistance of a professional.

In accordance with the principles of the present invention, a garment for the human body provides relaxing (therapeutic) effects on the neck and the upper back and shoulder regions. A garment of the present invention comprises a flexible, supportive cervical collar that secures the head and neck. The cervical collar is secured to a partially fitted, flexible upper body vest. The vest portion includes weighted ballast. A plurality of vibrators are provided on the vest located strategically at certain muscular/acupuncture sites.

### BRIEF DESCRIPTION OF THE DRAWING

FIG. 1 is an internal view of the human muscular system of the back and neck having a garment of the present invention shown in phantom.

FIG. 2 is perspective front view of a garment of the present invention shown on a human subject.

FIG. 3 is a perspective back view of a garment of the present invention shown on a human subject.

FIG. 4 is perspective side view of a garment of the present invention shown on a human subject.

FIG. 5 is perspective back view of a garment of the present invention showing the vibrators and electronic system of the garment of FIGS. 1-5 in phantom.

FIG. 6 is perspective detailed view of the collar of the garment of FIGS. 1-5.

### DETAILED DESCRIPTION OF THE INVENTION

In overview, a garment for the human body in accordance with the principles of the present invention provides relaxing (therapeutic) effects on the neck and the upper back and shoulder regions. A garment 10 of the present invention is comprised of a flexible, supportive cervical collar 12 that secures the head and neck. The cervical collar 12 is secured to a partially fitted, flexible upper body vest 14. The vest includes weighted ballast. A plurality of vibrators 18 are provided located strategically on the vest 14 at muscular/acupuncture sites.

Combining principles of acupressure and acupuncture, a garment of the present invention creates a general relaxation, calmness, and reduction of tension and stress by stimulation of the parasympathetic nervous system. This results in an effect of sedation rather than stimulation of the sympathetic nervous system, which is involved in the “fight of flight” response. This helps improve general well being, calmness and clarity of thought, and improved focus and concentration.

A garment of the present invention provides relaxing (therapeutic) effects on the neck and the upper back and shoulder regions. In particular, the garment targets the posterior neck region, the suprascapular region, the interscapular region, the vertebral region, the scapular region, and the infrascapular region. The targeted muscle groups include the Trapezius (A), the Rhomboid (major and minor), the Levator Scapulae (B), the Deltoid (C), the Serratus Posterior Superior, the Supraspinatus, and the Erector Spinae muscles. These muscles comprise significant muscles that can contribute to headaches; blurred vision and pain behind the eyes; facial pain; pain to the sinuses, the teeth, and the tongue; balance problems such as dizziness, fainting, staggering or even falling; hearing loss and ear pain; and eye problems such as drooping eyelids, watery eyes and reddening.

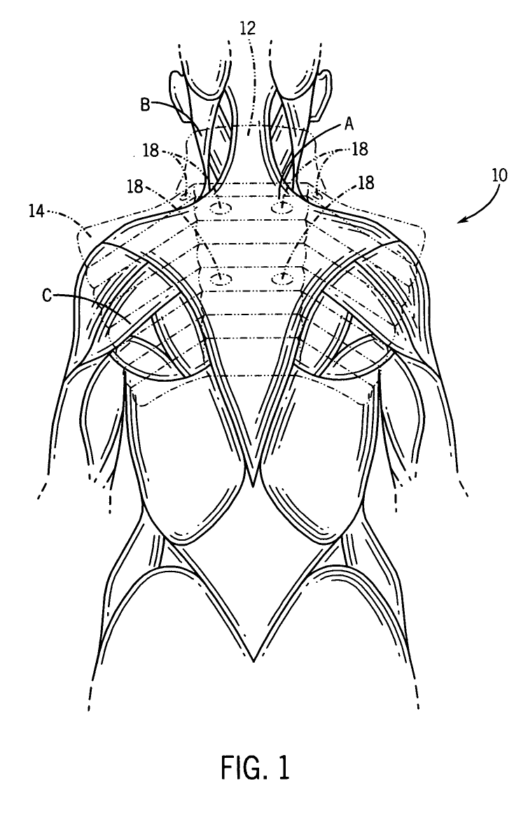

Referring to FIG. 1, an internal view of the human muscular system of the back and neck having a garment of the present invention shown in phantom is seen. The Trapezius (A) lies just below the skin, and is a flat, triangular muscle covering the upper and back part of the neck and shoulders. The Trapezius is one of the biggest back muscles and the most superficial muscle on the back of the neck and upper trunk. The Trapezius links the neck with the dorsal vertebrae (spine), ribs, and scapula (shoulder blade). The Trapezius serves multiple actions involving pulling the scapula (shoulder blade) towards its various attachments. The Trapezius is used to turn and tilt the head, raise and twist the arms, and to shrug or steady the shoulders.

The Trapezius is a major source of headache pain, typically the type of pain experienced as a “tension headache.” The Trapezius also can cause dizziness and jaw and toothache pain. Computer users and others who use their arms for extended periods often derive a burning pain between the scapulas (shoulder blades). Referred pain from the Trapezius and Levator Scapulae also can be found in such a wide variety of locations, including shoulder bursitis, headaches, disc compression or a “pinched nerve.”

The Rhomboid muscle lies beneath the middle portion of the Trapezius (in the middle of the back)(and is therefore not shown in FIG. 1). The Rhomboideus major and the Rhomboideus minor form a flat, quadrilateral muscle of the upper back that lie under the Trapezius. The Rhomboideus major and the Rhomboideus minor extend from the dorsal vertebrae (spine) to the medial or vertebral edge of the scapula (shoulder blade). The Rhomboideus major and the Rhomboideus minor are barely separable as two muscles. These muscles assist in scapular retraction and stabilization during shoulder movements. The position of the Rhomboid muscles (under the Trapezius) makes them difficult to reach by massage or manual manipulation.

The Rhomboids are very thin muscles which have responsibility for movement of the scapula (shoulder blade). Due to the enormous amount the scapula (shoulder blades) are used, the Rhomboids are often overworked and over tired. The pain generally extends from the medial or vertebral edge of the scapula (shoulder blades) to the dorsal vertebrae (spine). Since the Rhomboids on both sides are almost always affected, this is a primary source of mid back tightness or aching between the scapula (shoulder blades). This pain is felt when the muscles are in use, but also at rest.

The Levator Scapulae (Levator Anguli Scapulae) (B) is a small muscle situated at the back and side of the neck that lies beneath the Trapezius. The Levator Scapulae originates deep in the side of the neck near the base of the mastoid process (a part of the skull), passes down and back and inserts in the scapula (shoulder blade). The main function of the Levator Scapula is to elevate or raise the scapula (shoulder blade). This muscle tenses up, becoming hard and stiff, when a weight is carried on the shoulder. Stress and tension keep the shoulders raised, creating increased tension on the Levator Scapulae. Poor posture also can be a factor. The Levator Scapulae is typically involved when difficulty develops in turning the head.

The Deltoid (C) are thick triangular muscles that cup the shoulder joint. The deltoid muscles are composed of three groups of muscles which form a delta shape from the acromion (the projection of the shoulder blade that forms the point of the shoulder superiorly), scapula (shoulder blade) posteriorly and the clavicle (collar bone) anteriorly to the insertion on the humerus (upper arm bone) at the deltoid tuberosity. The Deltoid is divided into three portions: an anterior (clavicular) portion, an acrominal (middle) portion, and a posterior portion. Almost any movement of the shoulder and upper arm involves the deltoid muscle. The anterior portion is used to raise the arm from the body and to lower it again. The acrominal portion is a powerful abductor and the posterior portion is used to move the arm backward.

The Deltoid can cause poor posture due to the dominance of the anterior (clavicular) portion which are usually more prominent than the other two (acrominal (middle) portion and a posterior portion). The actions of the muscles aid in elevation of the shoulder, forward flexion, horizontal adduction, abduction, and extension. The Deltoid can aid in causing rotator cuff problems by forcing internal rotation with muscle imbalances. If the shoulder muscles cannot be used, the body is used to compensate in movements.

The Serratus Posterior Superior and Serratus Posterior Inferior muscles lie deep on the front part of the neck)(and are therefore not shown in FIG. 1). The Serratus Posterior Superior looks very similar to the Rhomboid muscles, but is, in fact, very different. The Serratus Posterior Superior is a thin, flat, quadrilateral muscle that extends from the neck to the third, fourth, and fifth ribs. The Serratus Posterior Inferior is broader than the Serratus Posterior Superior and extends to the four lower ribs. The Serratus Posterior Inferior and the Serratus Posterior Superior aid in respiration. The primary function of both the Serratus Posterior Superior and Serratus Posterior Inferior is to help raise the ribcage when breathing. The Serratus Posterior Superior elevates the ribs during inhalation, and the Serratus Posterior Inferior pulls the ribs down and back to exhale.

When these muscles are stressed, breathing becomes more shallow and short; during relaxed states, respiration is usually longer and deeper. In addition, the Serratus Posterior Superior can cause a deep aching pain under the scapula (shoulder blade). Additionally, pain or numbness can be found in the back of the shoulder, the elbow, and the pinky finger of the hand. Finally, the Serratus Posterior Superior can refer pain to the back of the upper arm and forearm, as well as the pectoral, or chest region.

The Supraspinatus muscle is attached along the broad inner and upper border of the scapula (shoulder blade). The Supraspinatus narrows into a strong tendon that joins firmly to the top of the humerus (upper arm bone). The Supraspinatus muscle runs along the top of the shoulder under the Trapezius muscle)(and is therefore not shown in FIG. 1). The Supraspinatus works with the Infraspinatus muscle to help lift and twist the upper arm. The Supraspinatus also helps to protect the shoulder joint by keeping the head of the humerus (upper arm bone) in place.

Working on the computer with no elbow support, carrying a heavy purse or briefcase or moving heavy objects can overwhelm the Supraspinatus. The Supraspinatus can cause a deep, aching pain in the shoulder. It can become extremely painful, if not impossible, to raise the arm above the shoulder. This interferes with many simple, daily tasks, and makes normal life very difficult. The Supraspinatus also can refer pain into the lateral or outside of the arm mimicking a cervical disc problem and sometimes into the outer portion of the elbow. This pain is often misdiagnosed as Lateral Epicondylitis—more commonly known as “Tennis Elbow.”

The Erector Spinae consists of three columns of muscle along either side of the dorsal vertebrae (spine)(and are therefore not shown in FIG. 1). They include the Longissimus, the Spinalis and the Iliocostalis. The muscles of the Erector Spinae attach to the vertebrae (spinous processes), the ribs, and the pelvis. The functions of the Erector Spinae group are to keep the vertebral spine erect, to maintain the arch of the back, and to support the back and all body parts above the waistline. The Iliocostalis muscles are the lateral column of muscles that attach to the angles (or posteriorly bent portion) of the ribs; the Longissimus muscles are the intermediate column of muscles that attach (superiorly) to the thoracic and cervical vertebrae and (transversely) to the lateral posterior base of the mastoid process (a part of the skull); the Spinalis muscles are the middle column of muscles that attach (superiorly) and connect the vertebrae (spinous processes) from the mid to upper back. These muscles link the vertebrae (spinous processes), helping maintain upright posture while standing and enabling bending and twisting.

Because these muscles attach to the vertebrae (spinous processes), they can cause problems with spinal misalignment and damage to the intervertebral discs. The pain can feel like it originates in the spine itself. The muscles feel hard and rigid, causing stiffness and decreased range of motion. It can feel as though the entire back is in spasm. Extreme and chronic tension in these muscles can lead to scoliosis, or a curvature of the spine. Due to the close relationship of these muscles with the dorsal vertebrae (spine) and nerves, these muscles can also cause pain that mimics problems with organs of the chest and abdomen, such as appendicitis, kidney stones, angina, bowel, and resiratory problems.

During the application of the relaxing (therapeutic) effects on the neck and back regions as more particularly described below, the flexible, supportive cervical collar provides support to the muscles responsible for extension, rotation, and lateral bending of the head; retraction of the head backwards; protraction, elevation, rotation and flexion of the vertebral column; and elevation of the first and second rib to aid in breathing. These muscles include the Semispinalis Capitis, the Splenius Capitis and Cervicis, the Semispinalis Cervicis, the Longissimus Capitis and Cervicis, the Iliocostalis Cervicis, the Sternocleidomastoid, the Scalenes, the Suboccipitals, the Rectus Capitis Posterior Major and Minor, the Obliquus Capitis Superior and Inferior, the Sternohyoid and Sternothyroid, and the Longus Colli muscles.

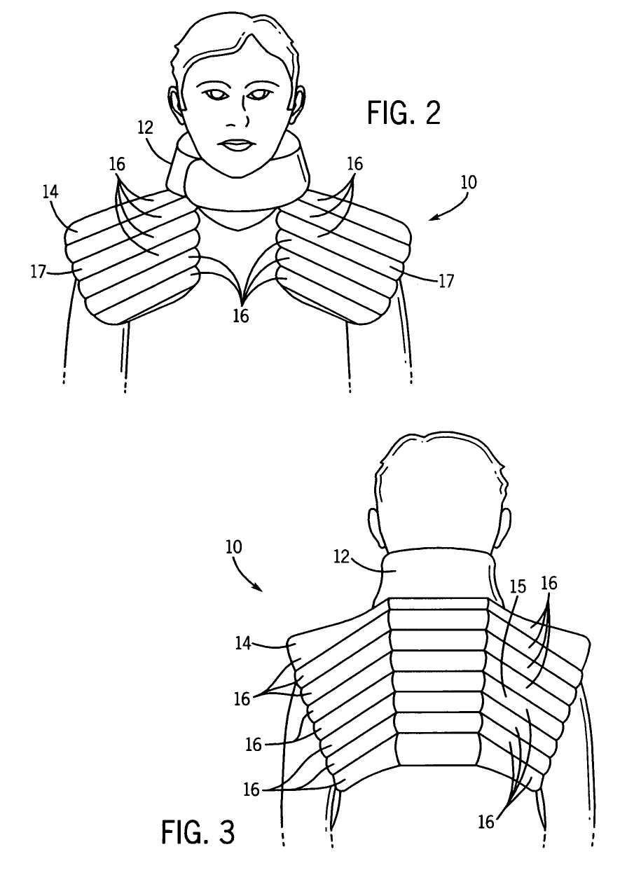

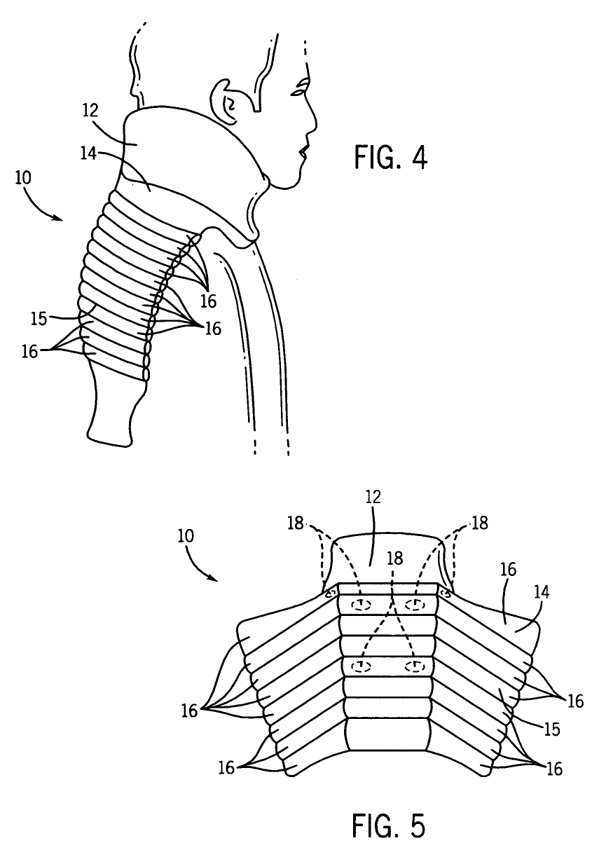

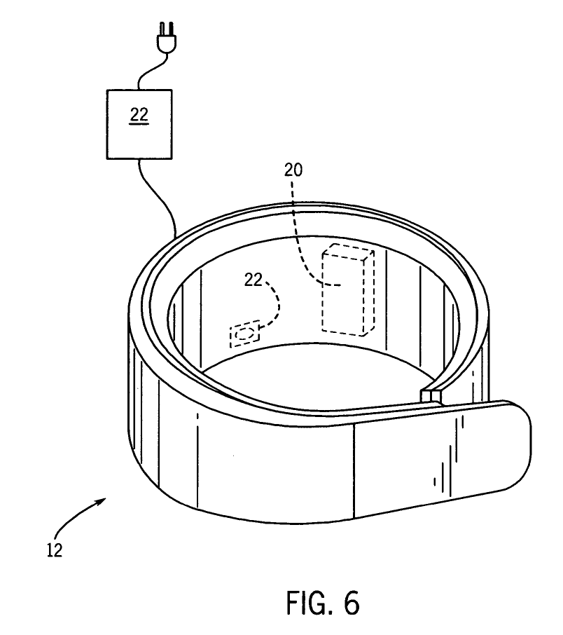

Referring now to FIGS. 2-6, various views of a garment of the present invention are seen: FIGS. 2-4 show perspective views of a garment of the present invention on a human subject; FIG. 5 shows a perspective back view of a garment of the present invention showing the electronic system in phantom; FIG. 6 shows a perspective detailed view of the cervical collar. The garment 10 is comprised of a flexible, supportive cervical collar 12 that secures the head and neck. In one embodiment, the cervical collar 12 is comprised of a foam strip encased in a fabric cover. The cervical collar 12 is of greater width in the back than the front so as to be the same height circumferentially to provide the back of the neck with appropriate support. In a preferred embodiment, the cervical collar 12 includes a front releasable closure 14. In a further preferred embodiment, the front releasable closure is a hook and loop style closure.

The cervical collar 12 is secured to a partially fitted, flexible upper body vest 14. The vest 14 comprises a back portion 15 shaped to be fitted on the back of a user to approximately the mid point of the back. The back portion 15 is connected to two front flaps 17 that extend partially on the chest of a user. The back portion 15 and front flaps 17 are tailored to conform to the shape of the human back and chest. In conjunction with the front releasable closure 14 of the cervical collar 12, the front flaps 17 are separate to enable the vest 14 to be placed on the user. The vest 14 includes weighted ballasts. With the ballasts, the vest weighs approximately 1½ kilograms. In one embodiment, a plurality of horizontal chambers 16 comprise the ballast. In a further embodiment, the plurality of horizontal chambers 16 comprises a plurality of sealed polyethylene tubing containing sand.

A plurality of vibrators 18 are provided on the vest located strategically at certain muscular/acupuncture sites, as described in detail below. A rechargeable battery 20 can be encased in an aperture defined in the cervical collar 12 and can be powered by a plug-in transformer unit 22. An on/off switch 22 is further provided in an additional aperture defined in the cervical collar 12. Appropriate wiring provides electronic connection among the battery 20, the on/off switch 22, and the vibrators 18.

A garment of the present invention provides stimulation to the Trapezius (A), the Rhomboid (major and minor), the Levator Scapulae (B), the Deltoid (C), the Serratus Posterior Superior, the Supraspinatus, and the Erector Spinae muscles. It is a particular advantage of the present invention that stimulation is provided to muscles that are difficult to reach by massage or manual manipulation. For example, the present invention provides sufficient stimulation to the Rhomboid muscle that lies beneath the middle portion of the Trapezius for tension relief. Further, the present invention provides stimulation to the Serratus Posterior Superior and Serratus Posterior Inferior muscles that lie deep on the upper and lower part of the back attached to the ribs. Likewise, the present invention provides stimulation to the Erector Spinae columns of muscle located along either side of the dorsal vertebrae (spine). Of course, the present invention provides tension relief to the Trapezius, the Levator Scapulae, the Deltoid, and the Supraspinatus as well.

In one embodiment, six vibrator motors 18 are provided. Each vibrator motor is designed to provide application of high frequency massaging pulses to key sites of the neck and back. The vibrator motor is preferably small in size while maintaining a high frequency. In one embodiment, a vibration motor model number MR-2231 available from Sanyo Seimitsu, Inc., 1771 Nakamaruko, Maruko City, Nagano Prefecture, Japan is used. The MR-2231 vibration motor is approximately 7.4 mm by 12.0 mm orientated horizontal, weighs approximately 2.4 g (with the counterweight weighing approximately 1.0 g), has a standard voltage of 1.3V, has a voltage range of 1.0 V˜1.7 V, and has a standard load of R=3, t=4.0.

The model number MR-2231 vibrator motor has a standard speed of 7000±1500 rpm at standard load and voltage, a standard current of 65±15 mA or less at standard voltage and load, and an actuation current (interlock current) of 1 00±20 mA (2/3R, R:1 polar resistance ratio) at standard voltage.

The ballast helps position the vest and therefore the vibrations at the strategically located muscular/acupuncture sites. In addition, the vibrator motor is contained in a housing unit. The housing unit helps to focus or channel the vibrations at the strategically located muscular/acupuncture sites. The housing unit is generally cylindrical shaped and can be made of plastic.

In an additional embodiment, the vest can be encased in an outer cover to maintain the cleanliness of the vest. In a further embodiment, the outer cover can be of various fabric designs.

During times of stress, both physical and emotional, our nervous system—specifically the sympathetic system—takes over (also known as the “fight or flight” response). The relaxing (therapeutic) effects delivered by the present invention on the neck and shoulder regions counteract the effects of our alarm reactions by protecting and neutralizing the effects of stress, the most dangerous trigger and stimulus for poor health. The stimulated sites are strategically chosen to help with headaches, respiration, relaxing the neck and upper back, relaxing the mind and body, stress and tension reduction, improved blood circulation, calming the nervous system, and improving general well being for optimal health during times of physical and emotional duress.

By stimulating these sites, energy flows through the channels that maintain the health of that area and organ system; however, if there is a disruption, a blockage due to trauma, physical or emotional, the flow of energy is disrupted and can lead to pain, discomfort, and dysfunction. Therefore, to allow normal functions to occur, proper stimulation in accordance with the principles of the present invention can be of great benefit.

The preferred targeted sites comprise specific points on the Gall Bladder, and the Lung and Heart channel/meridian. The Gall Bladder channeumeridian is associated with the Liver, which has an effect on the muscles, tendons, ligaments, and nerves of the body. The Lung channeumeridian is good for relaxing the resipatory mechanism so that deeper, more relaxing and slower breaths can be taken. The Heart channeumeridian calms and slows down the heart rate, lowers the blood pressure, and helps focus the mind.

In more particular, two vibrator motors 18 are provided targeted to the Gall Bladder #21 (GB21) or Jianjing site in acupuncture terminology. The acupuncture point Gall Bladder #21 is located midway between the interspinous processes of the seventh cervical vertebrae (C7) and the first thoracic (T1) vertebrae and acromion, at its highest site. In Traditional Chinese medicine, the Gall Bladder is the element of Wood, the Yang counterpart of the Liver. It is associated with symptoms of bitter taste in the mouth, dizziness, headaches, deafness, tinnitus, and pain along the lateral aspect of the head and body. The Gall Bladder #21 site is useful for treating headaches; neck, shoulder, and upper back problems; and any problems related with the outer part of the upper or lower body.

Two vibrator motors 18 are provided targeted to the Bladder #13 (BL13) or Feishu site in acupuncture terminology. The acupuncture point Bladder #13 is located approximately 1.5 inches lateral to the border of the spinous process of the third thoracic (T3) vertebra. In Traditional Chinese medicine, the Bladder #13 site is the element of Metal, the Yin counterpart of the Large Intestine. The Bladder #13 site is the Back Shu or association point for the Lung. The Bladder #13 site is useful for treating pain in upper back/base of the neck at the upper border of the scapula (shoulder blade).

Two vibrator motors 18 are provided targeted to the Bladder #15 (BL15) or Xinshu site in acupuncture terminology. The Bladder #15 site is located approximately 1.5 inches lateral to the border of the spinous process of the fifth thoracic (T5) vertebra. In Traditional Chinese medicine, the Bladder #15 site is the element of Fire, the Yin counterpart to the Small Intestine. The Bladder #15 site is the Back Shu or association point for the Heart. The Bladder #15 site is useful for treating problems along the spinal regions, but this specific site stimulation is good for cardiac or heart related problems such as arrhythmias, heart disease, etc. The Bladder #15 site is good for pain between the scapula (shoulder blades) and mid back pain.

Thus, a garment in accordance with the principles of the present invention provides relaxing (therapeutic) effects on the neck and the upper back and shoulder regions. A garment in accordance with the principles of the present invention works to allow the body to work to balance and normalize physical and emotional functions. A garment in accordance with the principles of the present invention applies such relaxing (therapeutic) effects in a non-invasive manner and without the assistance of a professional.

While the invention has been described with specific embodiments, other alternatives, modifications, and variations will be apparent to those skilled in the art. All such alternatives, modifications, and variations are intended to be included within the spirit and scope of the appended claims.

What is claimed is:

1. A garment for providing relaxing (therapeutic) effects comprising:
a flexible, supportive cervical collar that secures the head and neck;
an upper body vest secured to the cervical collar, the vest including weighted ballast; and
a plurality of vibrators on the vest, the vibrators located at a plurality of acupuncture sites.

2. The garment of claim 1 further wherein the cervical collar comprises a front releasable closure.

3. The garment of claim 2 further wherein the front releasable closure is a hook and loop style closure.

4. The garment of claim 1 further wherein the weighted ballast comprises a plurality of horizontal chambers.

5. The garment of claim 4 further wherein the plurality of horizontal chambers comprises a plurality of sealed polyethylene tubing containing sand.

6. The garment of claim 1 further wherein the plurality of vibrators comprises a plurality of vibrator motors.

7. The garment of claim 6 further wherein the vibrator motor comprises a standard load speed of approximately 7000±1500 rpm.

8. The garment of claim 1 further wherein the vest is partially fitted.

9. The garment of claim 1 further wherein the plurality of acupuncture sites is six.

10. The garment of claim 1 further wherein the plurality of acupuncture sites includes a Gall Bladder channel/meridian site.

11. The garment of claim 10 further wherein the Gall Bladder channel/meridian site comprises the Gall Bladder #21 (GB21) or Jianjing.

12. The garment of claim 1 further wherein the plurality of acupuncture sites includes the Lung channel/meridian site.

13. The garment of claim 12 further wherein the Lung channel/meridian site comprises the Bladder #13 (BL13) or Feishu.

14. The garment of claim 1 further wherein the plurality of acupuncture sites includes the Heart channel/meridian site.

15. The garment of claim 14 further wherein the Heart channel/meridian site comprises the Bladder #15 (BL15) or Xinshu.

16. The garment of claim 1 further wherein a rechargeable battery is encased in the cervical collar and is powered by a plug transformer unit.

17. A garment for providing relaxing (therapeutic) effects comprising:
a flexible, supportive cervical collar that secures the head and neck;
an upper body vest secured to the cervical collar, the vest including weighted ballast; and
a plurality of vibrators on the vest, the vibrators located to target a plurality of areas of the human body.

18. The garment of claim 17 further wherein the cervical collar comprises a front releasable closure.

19. The garment of claim 18 further wherein the front releasable closure is a hook and loop style closure.

20. The garment of claim 17 further wherein the weighted ballast comprises a plurality of horizontal chambers.

21. The garment of claim 20 further wherein the plurality of horizontal chambers comprises a plurality of sealed polyethylene tubing containing sand.

22. The garment of claim 17 further wherein the vest is partially fitted.

23. The garment of claim 17 further wherein the vibrator comprises a vibrator motor having a standard load speed of approximately 700±1500 rpm.

24. The garment of claim 17 further wherein the areas of the human body are selected from the group comprising the posterior neck region, the suprascapular region, the interscapular region, the vertebral region, the scapular region, the infrascapular region, and combinations thereof.

25. The garment of claim 17 further wherein a rechargeable battery is encased in the cervical collar and is powered by a plug transformer unit.

26. A garment for providing relaxing (therapeutic) effects comprising:
a flexible, supportive cervical collar that secures the head and neck;
an upper body vest secured to the cervical collar, the vest including weighted ballast; and
a plurality of vibrators on the vest, the vibrators located to massage a plurality of muscle groups.

27. The garment of claim 26 further wherein the cervical collar comprises a front releasable closure.

28. The garment of claim 27 further wherein the front releasable closure is a hook and loop style closure.

29. The garment of claim 26 further wherein the weighted ballast comprises a plurality of horizontal chambers.

30. The garment of claim 29 further wherein the plurality of horizontal chambers comprises a plurality of sealed polyethylene tubing containing sand.

31. The garment of claim 26 further wherein the vest is partially fitted.

32. The garment of claim 26 further wherein the vibrator comprises a vibrator motor having a standard load speed of approximately 7000±1500 rpm.

33. The garment of claim 26 further wherein the muscle groups are selected from the group comprising the Trapezius, the Deltoid, the Rhomboid (major and minor), the Levator Scapulae, the Serratus Posterior Superior, the Supraspinatus, the Erector Spinae, and combinations thereof.

34. The garment of claim 26 further wherein a rechargeable battery is encased in the cervical collar and is powered by a plug transformer unit.
